(19) United States
(12) Patent Application Publication
(10) Pub. No.: US 2026/0058038 A1
(43) Pub. Date: Feb. 26, 2026

(54) DEVICE AND METHOD FOR PROCESSING A PLURALITY OF ELECTRICAL WIRES

(71) Applicant: komax Holding AG, Dierikon (CH)

(72) Inventor: Dominik STAUBLI, Horw (CH)

(73) Assignee: komax Holding AG, Dierikon (CH)

(21) Appl. No.: 19/250,340

(22) Filed: Jun. 26, 2025

(30) Foreign Application Priority Data
Aug. 21, 2024 (EP) 24195634.1

(51) Int. Cl. H01B 13/02; H01B 13/00

(52) U.S. Cl. CPC H01B 13/0221; H01B 13/0003

(57) ABSTRACT

A device for processing electrical wires includes a feed-side holding device configured for simultaneously holding all the trailing ends of the wires, an extraction-side holding device which can be displaced along a linear guide direction and is configured for holding the leading end of the wires, and a transfer device for taking over the trailing ends of the wires from a feed device and for transferring the trailing ends of the wires to the feed-side holding device, wherein the extraction-side holding device is configured to twist the respective end of the wires that is held, and wherein the transfer device includes at least two cable grippers, which are configured to assume at least two different distances from each other. The feed-side holding device can be displaced in the extension direction of the wire bundle.

### CROSS REFERENCE TO RELATED APPLICATIONS

Applicant claims priority under 35 U.S.C. § 119 of European Application No. 24195634.1 filed Aug. 21, 2024, the disclosure of which is incorporated by reference.

### BACKGROUND OF THE INVENTION

### 1. Field of the Invention

Embodiments of the present disclosure relate to a device and a method for processing a plurality of electrical wires, in particular in cable processing machines such as, for example twisting machines.

### 2. Description of the Related Art

In various industrial applications, wire bundles are required, which are obtained from individual wires by twisting. Typically, the individual wires are cut to a specific length before being twisted, i.e. cut to size and, if necessary, also assembled ready for use, i.e. provided with a contact part or the like.

An example of a conventional device is a cable processing machine that twists a plurality of electrical wires after the assembly process (cutting to length, insulation stripping, attaching grommets, contacts, etc.). Such a cable processing machine is also known as a twisting machine. It may be provided, for example, that a cable twisted by means of such a device, in particular a twisted wire pair, is fitted into a plug connector housing manually or automatically in a subsequent work step.

In some conventional devices and methods according to the prior art, the wire pair formed of the individual wires is clamped between a holding unit at one end of the wire and a twisting unit at the other end of the wire and twisted by rotating the twisting unit. Such a device is described, for example, in document EP 1 032 095 A2. Here, two wires are drawn in and assembled at the same time. The two wires are pulled out after the assembly of the two first, leading ends of the wire and transferred to the actual twisting device after the subsequent assembly of the second, trailing ends of the wire. This device comprises a stationary holding module that holds the trailing wire ends during the twisting process, as well as a twisting head (twisting unit) that is movable in the direction of the cable and grips the leading wire ends and twists them jointly. The resulting shortening of the wire pair during the twisting operation is compensated by a longitudinal displacement of the twisting unit. For example, the twisting unit is guided by closed-loop control using the measured tensile force in the cable. A transfer module or transfer device is used to transfer the two wires from a pivot unit (second pivot unit) to the holding unit. The ends of the wires are received, moved into the twisting axis by means of a pivoting and vertical movement, and the distance between them is reduced.

The length of the untwisted ends may vary, for example, to allow different products to be produced or processed. If the length of the ends is to be variable for processing different products, the transfer module must be able to transfer the cable ends at different positions relative to the grip position. Conventionally, the machines are reconfigured for this purpose, for example by replacing parts.

There is a need for a simple customization facility for processing different products.

### SUMMARY OF THE INVENTION

According to one aspect, a device for processing a plurality of electrical wires, for example two wires, is specified. The device comprises a feed-side holding device, an extraction-side holding device, and a transfer device. The feed-side holding device is configured to hold all the trailing ends of the plurality of electrical wires simultaneously. The extraction-side holding device is displaceable along a linear guide direction and configured to hold the leading end of the plurality of electrical wires. The extraction-side holding device is configured to twist the respective end of the wires that is held. The transfer device is configured to take over the trailing ends of the wires from a feed device and to transfer the trailing ends of the wires to the feed-side holding device. The transfer device comprises at least two cable grippers, in particular exactly two cable grippers. The cable grippers are configured to assume at least two different distances from each other. The feed-side holding device can be displaced in the extension direction of the wire bundle.

According to one aspect concerning a method that uses the device disclosed herein, such a method comprises assuming an end position of the cable grippers, moving the carrier into a transfer position, transferring the wires, and moving the carrier into an end position, and pivoting away for taking over further wires to be processed.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

### In the Drawings,

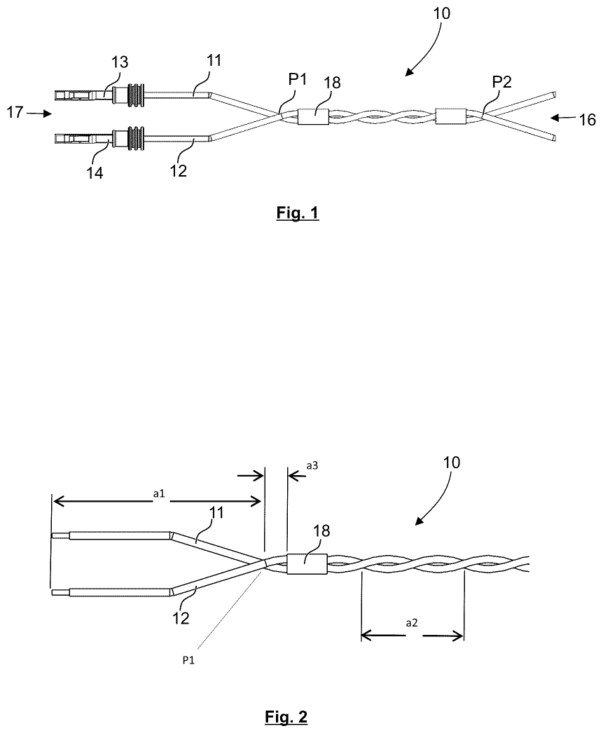

FIG. 1 shows a schematic representation of a region of a wire bundle for the purpose of explaining the terms used herein;

FIG. 2 shows a region of the wire pair from FIG. 1 with further aspects for explanation;

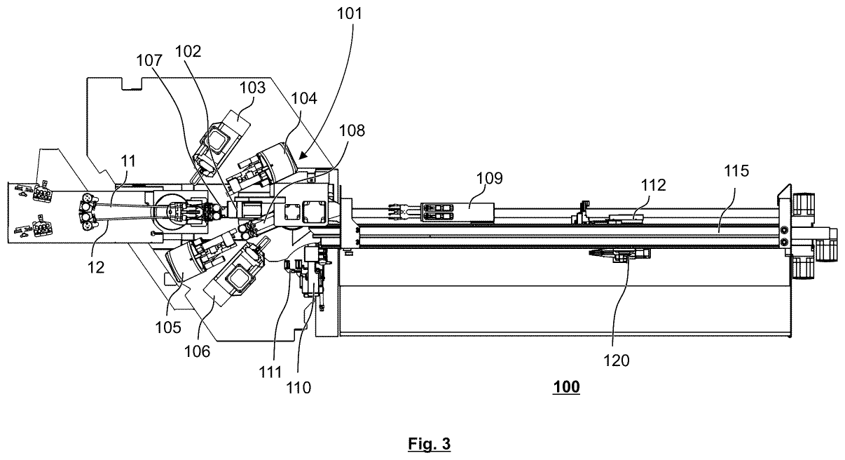

FIG. 3 shows a schematic side view of a device for twisting individual wires according to an embodiment;

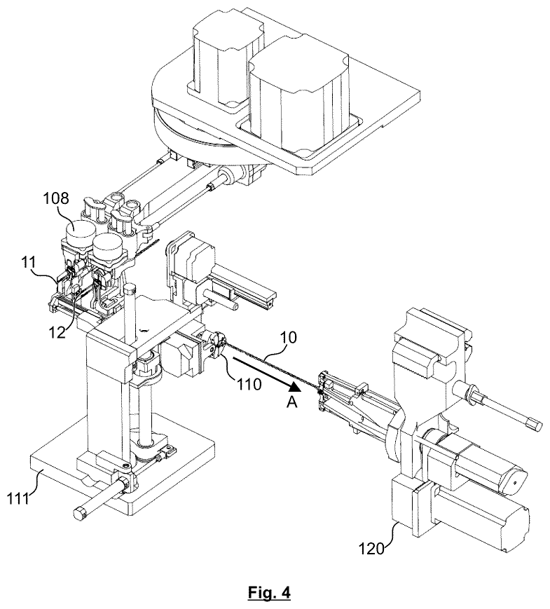

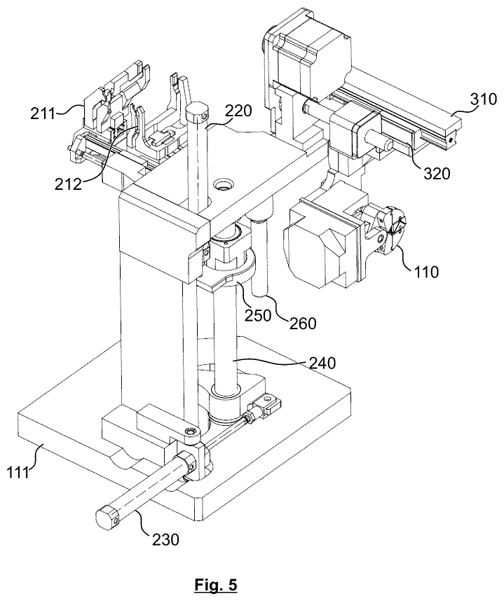

FIG. 4 shows a perspective view of parts of the device of FIG. 3;

FIG. 5 shows a perspective view of parts of the device of FIG. 3;

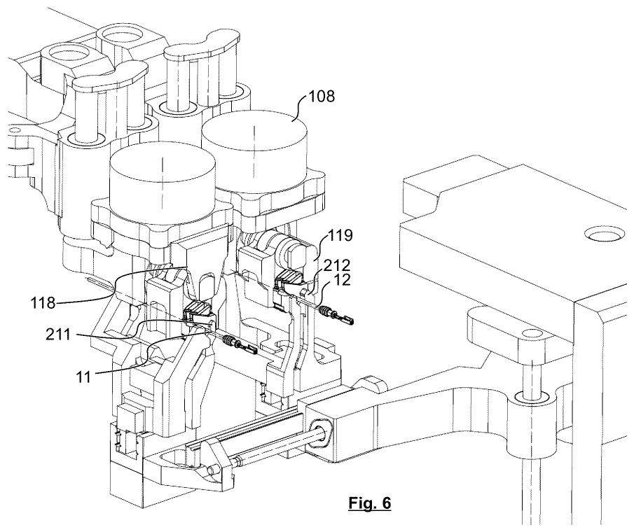

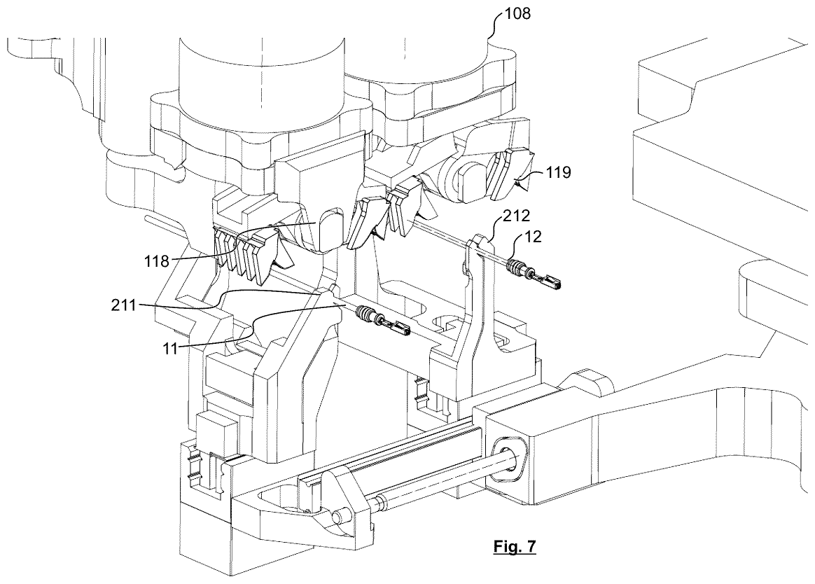

FIG. 6 shows a perspective view of parts of the device of FIG. 3 during a re-gripping operation;

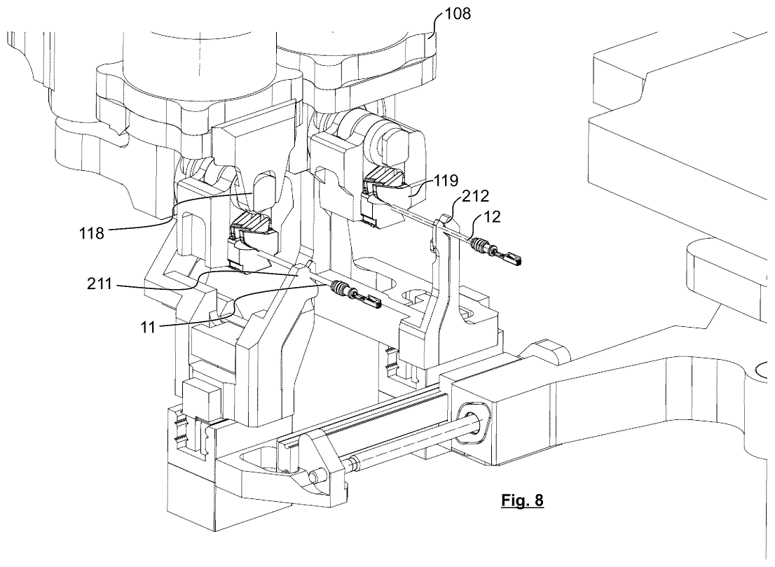

FIG. 7 shows a perspective view of parts of the device of FIG. 3 during the re-gripping operation;

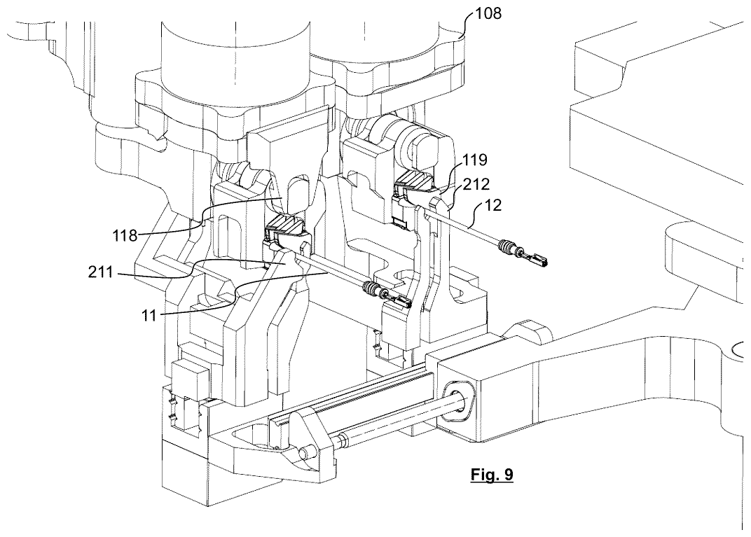

FIG. 8 shows a perspective view of parts of the device of FIG. 3 during the re-gripping operation;

FIG. 9 shows a perspective view of parts of the device of FIG. 3 during the re-gripping operation;

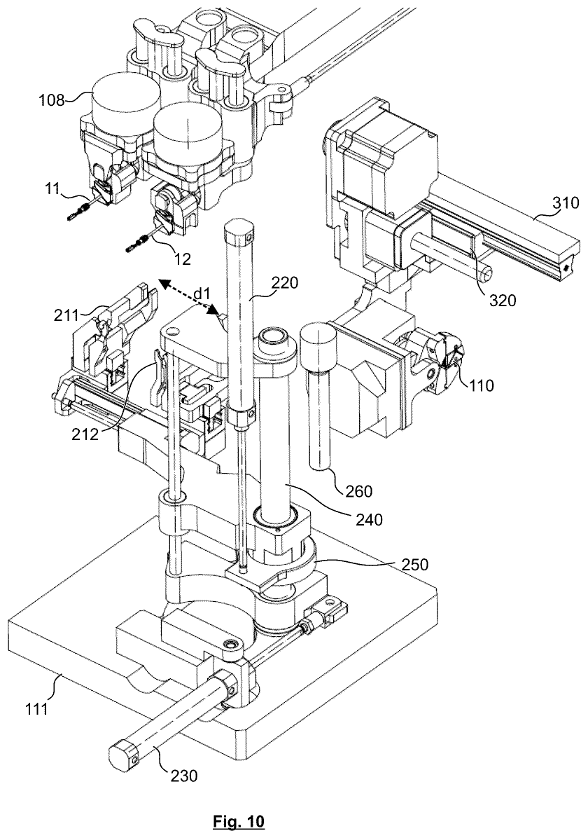

FIG. 10 shows a perspective view of parts of the device of FIG. 3, for the explanation of a method according to an embodiment;

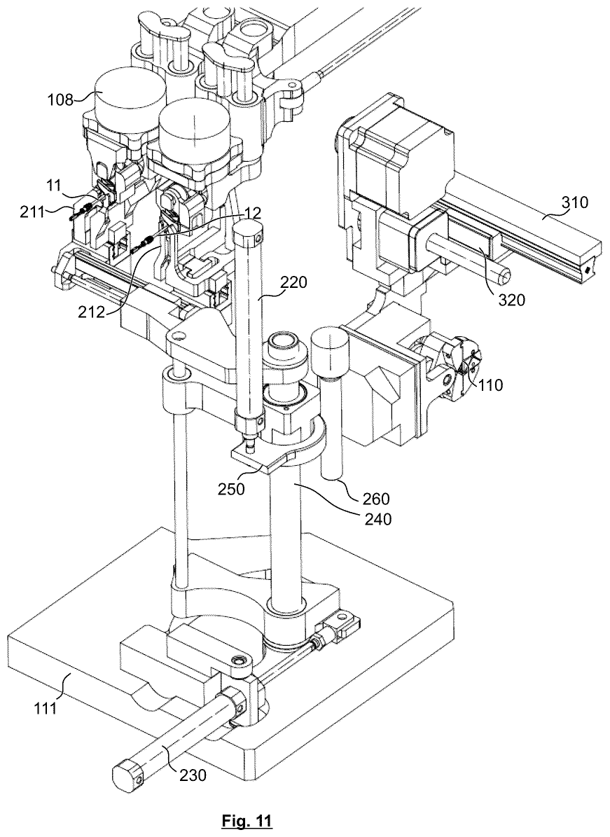

FIG. 11 shows a perspective view of parts of the device of FIG. 3, for the explanation of the method;

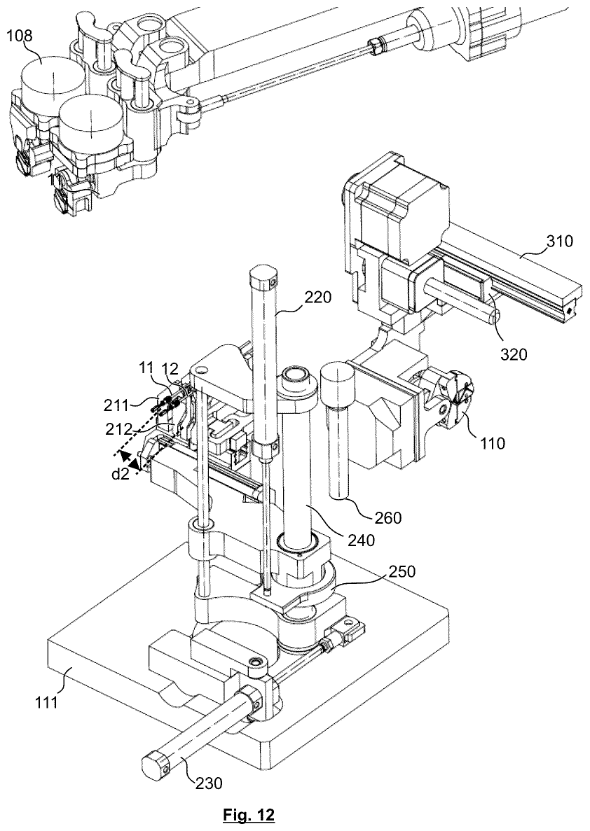

FIG. 12 shows a perspective view of parts of the device of FIG. 3, for the explanation of the method;

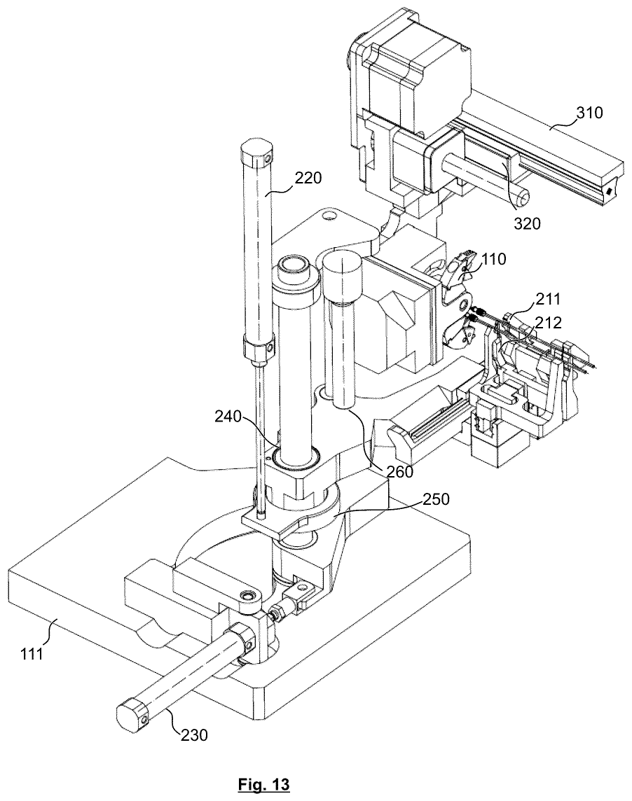

FIG. 13 shows a perspective view of parts of the device of FIG. 3, for the explanation of the method;

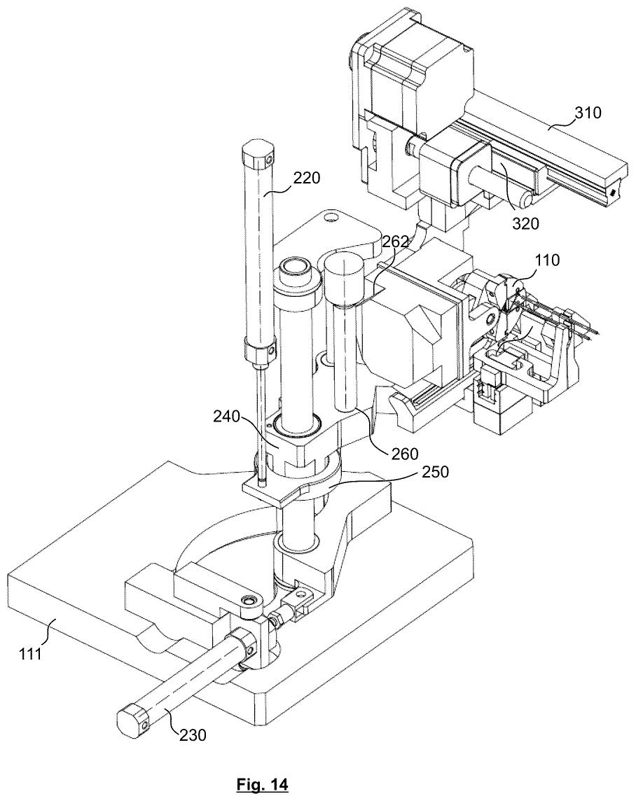

FIG. 14 shows a perspective view of parts of the device of FIG. 3, for the explanation of the method;

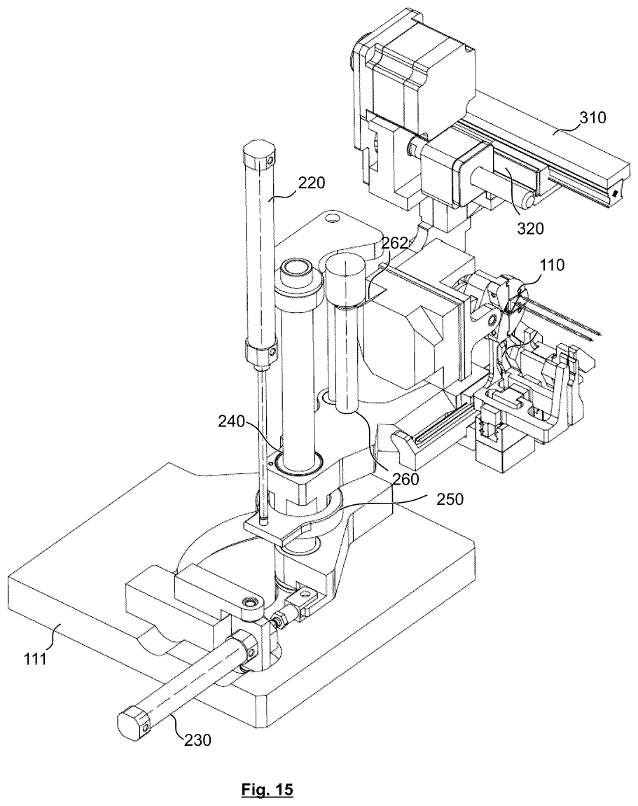

FIG. 15 shows a perspective view of parts of the device of FIG. 3, for the explanation of the method; and

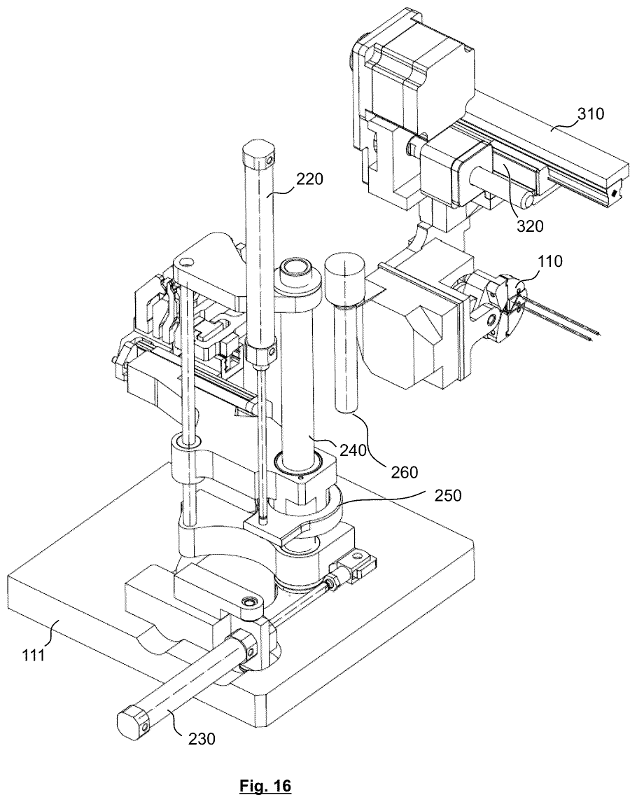

FIG. 16 shows a perspective view of parts of the device of FIG. 3, for the purpose of explaining the method.

### DETAILED DESCRIPTION OF PREFERRED EMBODIMENTS

FIG. 1 shows a twisted wire pair 10 of a first individual wire 11 and a second individual wire 12, thus a schematic representation of a region of a wire bundle, which is designated as a whole by reference numeral 10. The wire bundle comprises an individual wire 11 and an individual wire 12, as a wire pair. It should be noted that the number of two individual wires 11, 12 is exemplary and not limiting, and that the aspects and features described herein are also fully or partially applicable to wire bundles with more than two individual wires 11, 12 and result in identical or similar effects. In embodiments, however, two individual wires 11, 12 can be used for a wire bundle 10.

One end 16 of the wire pair 10 is defined as the leading end, which is guided in a device 100 described later for twisting. The other end 17 of the wire pair is defined as the trailing end.

At the trailing end 17, a first contact 13 and a second contact 14 are attached to the wires 11 and 12 respectively. A region between the ends 16, 17 is twisted, i.e. the wires 11, 12 wrap around each other. Starting from the leading end 16, the wires 11, 12 intersect or cross each other for the first time at a first intersection point P2.

Similarly, the wires 11, 12 starting from the trailing end 17 intersect or cross each other for the first time at a first intersection point P1.

In other words: in FIGS. 1, 17 designates a first side, for example on the side of the trailing wire ends, and 16 designates a second side, for example on the side of the leading wire ends. In a region which is located in FIG. 1 to the right of an adhesive strip 18, the individual wires 11, 12 are twisted, whereby in a projection plane, for example in the drawing plane of FIG. 1, points are produced at which the individual wires 11, 12 cross.

The term twisted, as used herein, denotes a condition in which the wires 11, 12 wrap around each other. A similar cross-over in the projection plane occurs when the same sequence of individual wires occurs at two crossings in the direction perpendicular to the projection plane.

For explanation purposes, a subregion of the wire pair 10 is shown again in FIG. 2. The untwisted ends of the individual wires 11, 12 at the trailing end of the wire have a length a1. The distance between two identical crossings or intersections of the wires 11, 12 in the twisted region is specified as the pitch length a2.

The distance a3 is defined in a direction which is substantially perpendicular to the extension direction of the wire pair 10, in which the distances a1, a2 are defined. The distance a3 indicates the distance between the individual wires 11, 12 at the respective end, in FIG. 2 at the trailing end 17. A corresponding distance a3, which is equal to or different in size from the distance a3 at the trailing end, is also defined at the leading end 16.

FIG. 3 shows a schematic side view of a device 100 for twisting individual wires according to an embodiment. In FIG. 3, the leading end 16 of the individual wires 11, 12 is guided into a processing region 101, from where they can be guided further along a machine axis on a guide rail 115. Processing modules 103, 104, 105, 106 can perform manipulations on the wires 11, 12 in the processing region 101.

The leading ends of the individual wires 11, 12 are stripped of insulation by a cutting head 102 and on the one side are successively fed to processing modules 103, 104 using a first pivot unit 107. Here, for example, a grommet and a contact can be fitted to the end of each conductor.

The first pivot unit 107 then moves the wire pair 10 back into the direction of the machine axis. There, the individual wires 11, 12 thereof are guided through until they can be gripped by an extraction carriage 109. Depending on the desired cable length, the individual wires 11, 12 are extracted by the extraction carriage 109 along the guide rail 105 in the linear guide direction defined by said guide rail.

The individual wires 11, 12 are then gripped by a second pivot unit 108 and severed and stripped of insulation by the cutting head 102. The trailing conductor ends are fed by the second pivot unit 108 to the processing modules 105, 106 on the other side and fully assembled, i.e. for example, each being fitted with a grommet and a contact.

A transfer module 111 (a transfer unit) takes over the trailing end 17 of the individual wires 11, 12, reduces the distance between them and, after a pivot movement, transfers them to a feed-side holding device (holding module, holding gripper) 110. A transfer module 112 transfers the leading end 16 of the individual wires 11, 12 to a twisting head (extraction-side holding device) 120. At this point, the device 100 is ready for the actual twisting process. The twisting process is carried out by turning the twisting head 120, wherein it is simultaneously moved in the direction of the holding module 110 in a tension-controlled manner. The fully twisted cable then drops, for example, into a trough-shaped cable tray.

FIG. 4 shows a perspective view of parts of the device 100 of FIG. 3, namely the second pivot unit 108, the transfer unit 111, the holding gripper 110 and the twisting head 120 with a twisted wire bundle (conductor pair) 10 during the transfer of a further conductor pair of individual wires 11, 12 from the second pivot unit 108 to the transfer module 111.

FIG. 5 shows the transfer unit 111 and the holding gripper 110 with further details. The transfer unit 111 comprises a first cable gripper 211 for gripping and holding the first individual wire 11, and a second cable gripper 212 for gripping and holding the second individual wire 12. The two cable grippers 211, 212 are, for example, pneumatically actuated, but not limited thereto, and can also be actuated, for example, by electric motor or in a different way. The two cable grippers 211, 212 are arranged on a carrier 250. The two cable grippers 211, 212 are configured such that they can assume, i.e. take on, at least two different distances d1, d2 from each other, as further explained below with reference to FIG. 10 and FIG. 12. For example, the distance d1, d2 between the cable grippers 211, 212 can be changed pneumatically, for example on a guide by means of a pneumatic cylinder. However, the type of actuation is not limited thereto, and the distance can also be changed, for example, by electric motor or in a different way. The distance from each other refers to a distance perpendicular to the cable extension direction. By changing this distance, the distance between the individual wires 11, 12 is changed without the individual wires being moved in their extraction direction (along the cable axis).

The carrier 250 encloses a column 240 and is displaceable by means of an actuating device, for example and without limitation by means of a pneumatic lifting cylinder 220, into a central position and at least one of a lower end position and an upper end position. The central position is further described below with reference to FIG. 14. FIG. 5 shows the carrier 250 in its upper end position. A stroke limiting element or stroke limiter 260 serves as a stop for the carrier 250. The carrier 250 is linearly displaceable in a rotationally fixed manner on the column 240, in the drawings in the upward-downward direction or vertical direction. In order to realize the rotationally fixed linear movement, the column 240 can be designed, for example, as a splined shaft. The carrier 250, linearly displaceable in a rotationally fixed manner about the column, is pivotable together with the column 240, for example and without limitation, by means of a hydraulically actuated pivot cylinder 230. Therefore, the stroke limiting element 260 acts only in a certain pivot angle range of the carrier 250. The stroke limiting element 260 causes the carrier 250, when located in the relevant pivot angle range, to collide with the stroke limiting element 260 in the vertical direction in the drawings in order to reach the central position. In other words: the vertical position of the stroke limiting element 260 defines the central position of the carrier 250 for a certain pivot angle range.

The feed-side holding device 110 (the holding gripper) is displaceable in the direction of the twisting axis (i.e. toward the extraction-side holding device 120—the twisting head—or away from it), preferably linearly displaceable and in particular, displaceable in a program-controlled manner. For example, the feed-side holding device 110 is mounted on a linear guide and can be moved, for example, by means of a threaded or ball screw. The gripper jaws of the holding gripper 110 are designed such that they can receive the two conductor ends 11, 12 in a pair of jaws. Alternatively, the holding gripper 110 has a pair of gripping elements, each holding a conductor end 11, 12. In this case, the gripping elements can be moved jointly in the cable direction. In both cases, the distance between the conductor ends 11, 12 can be advantageously kept very small.

FIGS. 6 to 9 show a re-gripping process during the transfer of the wires 11, 12 from the second pivot unit 108 to the transfer device 111. The second pivot unit 108 comprises a pivot unit first cable gripper 118 and a pivot unit second cable gripper 119. In FIG. 6 the second pivot unit 108 transfers the wires 11, 12 between the two legs of the cable grippers 211, 212, opens the pivot unit cable grippers 118, 119 in FIG. 7, travels back along the cable axis and in FIG. 8 closes the pivot unit cable grippers 118, 119 again. Then the cable grippers 211, 212 of the transfer device 111 open and the second pivot unit 108 travels again into the frontal region to transfer the wires 11, 12 there. This re-gripping can also be repeated several times to achieve the desired position of the wires. Although such a re-gripping process can also be used in principle in a device disclosed herein and a method disclosed herein, it is no longer mandatory. The ability to displace the holding gripper (of the feed-side holding device 110) in the extension direction of the wire bundle in the device disclosed herein and, in the method disclosed herein, may fulfil the same or a similar purpose, so that a time-consuming re-gripping, as described above, can be advantageously avoided.

FIGS. 10-16 each show a perspective view of parts of the device 100 of FIG. 3, for the purposes of explaining a method in its method steps. FIG. 10 shows a starting position or a starting configuration for carrying out the method. The cable grippers 211, 212 of the transfer unit 111 are moved by means of the carrier 250 into a lower end position, and their distance d1 from each other is a comparatively large distance. For example, the distance d1 is approximately equal to the distance between the pivot unit cable grippers 118, 119. The second pivot unit 108 is located above the cable grippers 211, 212 of the transfer unit 111 and holds the two wires 11, 12 (which are usually assembled on one side).

In FIG. 11, the carrier 250 is moved into the upper end position and thus brings the cable grippers 211, 212 of the transfer unit into a transfer position. In this pivot angle region of the carrier 250, the carrier 250 can freely move past the stroke limiting element 260; the stroke limiting element 260 is therefore not active in this angular position of the carrier, and the upper end position can be approached.

After the transfer, in FIG. 12 the carrier 250 moves into the lower end position, and the second pivot unit 108 becomes free. It can then, for example, as shown in FIG. 12, be pivoted away in order to take over the next wire pair to be processed. This can be assembled, for example, in parallel with the twisting process. The cable grippers 211, 212 of the transfer device 111 are actuated such that they assume a distance d2 from each other which is smaller than the distance d1. For example, the distance d2 corresponds to the distance between the wire ends in the gripper jaws of the feed-side holding device 110.

As shown in FIG. 13, the pivot cylinder 230 retracts and thereby pivots the column 240 and the carrier 250 so that the wire ends are parallel to the twisting axis. In FIG. 13, the feed-side holding device 110 is shown in an open position; however, this position can also be assumed earlier.

As shown in FIG. 14, the feed-side holding device 110 is moved linearly until the gripper jaws are in a desired gripping area. In doing so, the feed-side holding device 110 can assume a position inside or outside the legs of the cable grippers 211, 212 of the transfer device 111.

The carrier 250 is now moved toward the stroke limiting element 260 (in the drawings in the vertical direction upwards), is stopped by the stroke limiting element 260 and thus assumes, i.e. takes on, the central position. The wires 11, 12 are then transferred by successively closing the feed-side holding device 110 and opening the cable grippers 211, 212.

The carrier 250 can then be moved back into the lower end position (FIG. 15).

The trailing cable ends of the wires 11, 12 can then be twisted.

By pivoting back and increasing the distance between the cable grippers 211, 212, the transfer device 111 can then be brought back into the starting position (FIG. 16).

The device 100 is characterized in that the wires 11, 12 in particular in the feed-side holding device (the holding gripper) 110 can be close to each other, so that an advantageous twisting quality results.

If the stroke limiting element 260 is provided, this allows the central position to be defined in a simple manner without the need for an additional actuator (for example, an additional pneumatic cylinder).

Although only a few embodiments of the present invention have been shown and described, it is to be understood that many changes and modifications may be made thereunto without departing from the spirit and scope of the invention.

What is claimed is:

1. A device (100) for processing a plurality of electrical wires (11, 12) comprising the following:
a feed-side holding device (110) configured to hold all trailing ends of the wires simultaneously;
an extraction-side holding device (120) that is displaceable along a linear guide direction and configured to hold the leading end of the wires, the extraction-side holding device (120) being configured to twist the respective end of the wires that is held; and
a transfer device (111) for taking over the trailing ends of the wires (11, 12) from a feed device (108) and for transferring the trailing ends of the wires (11, 12) to the feed-side holding device (110), wherein the transfer device comprises at least two cable grippers (211, 212), which are configured to assume at least two different distances (d1, d2) from each other;
wherein the feed-side holding device (110) is displaceable along the extension direction (A) of the wire bundle (10).

2. The device (100) according to claim 1, wherein the feed-side holding device (110) is displaceable in the extension direction (A) of the wire bundle (10) in a predeterminable manner, in particular a program-controlled predeterminable manner.

3. The device (100) according to claim 1, wherein the feed-side holding device (110) is linearly displaceable, in particular linearly displaceable along a linear guide (310).

4. The device (100) according to claim 1, wherein the cable grippers (211, 212) are arranged on a carrier (250) which is displaceable perpendicular to an extension direction of the wires (11, 12), in particular perpendicular to the extension direction (A) of the wires (11, 12).

5. The device (100) according to claim 4, wherein the carrier (250) is linearly displaceable along a column (240) in a rotationally fixed manner.

6. The device (100) according to claim 4, wherein the carrier (250) is displaceable at least between a central position and an end position.

7. The device (100) according to claim 6, wherein the end position is defined by a stroke limiting element (260).

8. The device (100) according to claim 6, wherein the carrier (250) and the column (240) are configured such that they perform a common pivot movement when the column (240) is rotated.

9. The device (100) according to claim 5, wherein the column (240) is implemented as a splined shaft.

10. The device (100) according to claim 5, further comprising a pivot cylinder (230) for rotating the column (240).

11. The device (100) according to claim 1, wherein the feed-side holding device (110) comprises a pair of jaws made of gripper jaws for receiving all trailing ends of the wires (11, 12).

12. The device (100) according to claim 1, wherein the feed-side holding device (110) comprises a plurality of holding grippers, each designed for receiving the trailing ends of the wires (11, 12), wherein the holding grippers are jointly displaceable in the extension direction (A) of the wires (11, 12).

13. A method for processing a plurality of electrical wires using the device according to claim 1, comprising:
assuming an end position of the cable grippers (211, 212);
moving the carrier (250) into a transfer position;
transferring the wires (11, 12);
moving the carrier (250) into an end position, and pivoting the carrier (250) away to take over further wires to be processed.

14. The method according to claim 13, further comprising:
retracting the pivot cylinder (230) to pivot the column (240) and carrier (250) so that the wire ends run parallel to the extension direction (A);
setting a distance between the cable grippers (211, 212) corresponding to a distance between the ends of the wires (11, 12) on the feed-side holding device (110);
opening the feed-side holding device (110) and linearly displacing the feed-side holding device (110);
moving the carrier (250) towards the stroke limiting element (260) into the centre position;
transferring the wires (11, 12);
moving the carrier (250) into the end position;
increasing the distance between the cable grippers (211, 212).
